(19) United States
(12) Patent Application Publication
(10) Pub. No.: US 2013/0006956 A1
(43) Pub. Date: Jan. 3, 2013

(54) Computer Processing Method and System for Searching

(75) Inventors: Shao Chun Li, Beijing (CN); Li Wang, Beijing (CN)

(73) Assignee: International Business Machines Corporation, Armonk, NY (US)

(21) Appl. No.: 13/602,872

(22) Filed: Sep. 4, 2012

Related U.S. Application Data
(63) Continuation of application No. 13/449,429, filed on Apr. 18, 2012.

(30) Foreign Application Priority Data
Apr. 19, 2011 (CN) 201110097838.3

(51) Int. Cl. G06F 17/30

(52) U.S. Cl. 707/706; 707/E17.108

(57) ABSTRACT

The present invention provides a computer processing method and a system thereof for searching. The computer processing method includes: receiving a first keyword; performing search using the first keyword to obtain a first search result; receiving user evaluation of the first search result; in response to the evaluation being unsatisfactory, searching for associated keywords from a keyword data source based on the first keyword; recommending associated keywords to the user according to matching degrees of the associated keywords and the first keyword; and in response to that the user selects an associated keyword from the recommended associated keywords, performing search based on the associated keyword selected by the user. The related specific implementation of the present application will help a user to find an input keyword more effectively during a search so as to enable him/her get more satisfactory search result.

### CROSS-REFERENCE TO RELATED APPLICATION

This application is a continuation of and claims priority from U.S. patent application Ser. No. 13/449,429, filed Apr. 18, 2012, which in turn claims priority under 35 U.S.C. §119 from Chinese Patent Application No. 201110097838.3 filed Apr. 19, 2011, the entire contents of both are incorporated herein by reference.

### BACKGROUND OF THE INVENTION

1. Field of the Invention

The present invention generally relates to the technical field of information processing, more particularly, to a computer processing method and system for searching.

2. Description of the Related Art

Search engine, as a tool for people to acquire information, is becoming more and more important. However, it is usually difficult for users to determine accurate search keywords, and thus can not get satisfactory search results, and waste too much time on determining the correct search keywords. For example, a user desires to search for relevant information about community based work task development, and desires to acquire the up-to-date research status in this field. The keyword matching the user's search requirement is: crowdsourcing. However, since the user per se lacks related experiences or knowledge, he/she cannot provide an accurate keyword input. The keyword given by the user is outsourcing, and the search result given by a current search engine (e.g., Google, which is a trademark of Google Incorporation) is as shown in the figure, and the related searches including the listed outsourcing (other recommended keywords) do not have crowdsourcing either.

Current search engines will provide some extension to the keyword input the user, but the extended keywords all include the keyword input by the user, and thus once the user inputs an erroneous or inappropriate keyword, substantially the user does not have any auxiliary means to help him/her to get the correct keyword. In addition, some other technologies provide auxiliary keyword by analyzing logs of the search engine, and these technologies involve modifying the search engine fundamentally, and the effect is not obvious. As a result, the user can only depend on his/her knowledge to determine the accurate keyword. However, the user's knowledge is usually limited, and now with the development of Internet, various new information and knowledge are accumulated and updated, and the user is often unable to determine the correct keyword to find the information he/she is really interested in.

Therefore, a computer processing method and system for searching is needed.

### SUMMARY OF THE INVENTION

In one aspect of the present invention, there is provided a computer processing method for searching, including: receiving a first keyword; performing a first search using the first keyword to obtain a first search result; receiving user evaluation of the first search result; in response to the evaluation being unsatisfactory, searching associated keywords from a keyword data source based on the first keyword; recommending associated keywords to the user according to matching degrees of the associated keywords and the first keyword; and in response to that the user selects an associated keyword from the recommended associated keywords, performing a second search based on the associated keyword selected by the user.

In another aspect, the present invention provides a computer system for searching, the system including: a keyword collector configured to receive a first keyword; a search engine configured to perform search using the first keyword to obtain a first search result; a user interaction component configured to receive user evaluation of the first search result; a keyword searcher configured to, in response to the evaluation being unsatisfactory, search associated keywords from a keyword data source based on the first keyword; where, the user interaction component is further configured to recommend associated keywords to the user according to matching degrees of the associated keywords and the first keyword; and the search engine is further configured to, in response to that the user selects an associated keyword from the recommended associated keywords, perform search based on the associated keyword selected by the user.

Another aspect of the present invention provides a non-transitory computer readable article of manufacture tangibly embodying computer readable instructions which, when executed, cause a computer to carry out the steps of a computer processing method for searching, including:receiving a first keyword; performing a first search using the first keyword to obtain a first search result; receiving user evaluation of the first search result; in response to the user evaluation being unsatisfactory, searching for associated keywords from a keyword data source based on the first keyword; recommending the associated keywords to the user according to matching degrees of the associated keywords and the first keyword; and in response to the user selecting an associated keyword from the recommended associated keywords, performing a second search based on the associated keyword selected by the user.

### BRIEF DESCRIPTION OF THE DRAWINGS

Now refer to following accompanying drawings to describe in detail the features and advantages of embodiments of the present invention. If possible, same or similar reference numbers are used in the drawings and the description to denote the same or similar component, where:

FIG. 1 shows prior art of a situation and approach in which a current search engine provides extended keywords.

FIG. 2 shows a first specific implementation of a computer-implemented method for searching of according to an embodiment of the present invention.

FIG. 3 shows a second implementation of a computer-implemented method for searching according to an embodiment of the present invention.

FIGS. 4 and 5 show a third implementation of a computer-implemented method for searching according to an embodiment of the present invention.

FIG. 6 shows an implementation for forming a user feedback data source according to an embodiment of the present invention.

FIG. 7 shows a schematic diagram of a computer system for searching according to an embodiment of the present invention.

FIG. 8 schematically shows a structural block diagram of a computing device that can realize embodiments according to the present invention.

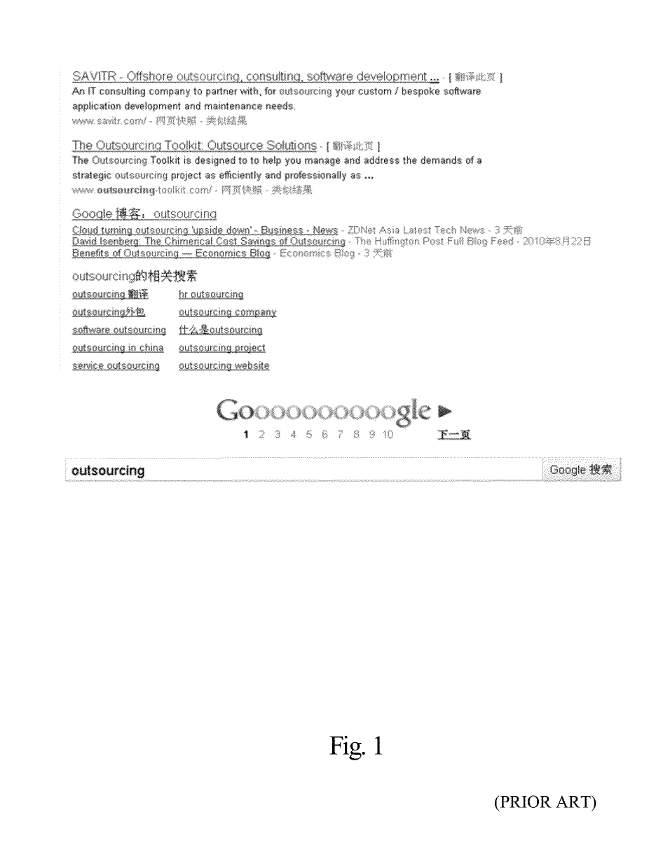

### DETAILED DESCRIPTION OF THE PREFERRED EMBODIMENTS

Now detailed description will be made by referring to exemplary embodiments of the present invention. The drawings illustrate examples of the embodiments, where the same reference numerals denote the same elements throughout. It should be appreciated that the present invention is not limited to the disclosed exemplary embodiments. It should also be appreciated that not each feature of the method and device is necessary for implementing the present invention claimed by any one of the claims. In addition, in the entire disclosure, when a processing or method is shown or described, the steps of the method can be executed in any order or simultaneously, unless it can be seen obviously from the context that one step is dependent on the other step executed earlier. In addition, there can be notable time intervals between steps.

Some specific implementations of the present invention can help the user, during search, to find the input keyword more effectively, so that he/she can get more satisfactory search results; during the process of finding the input keyword, a visualized interaction interface between the user and system is provided to enable the user to self-adjust according to dynamic results, so that the search path continuously tends to the user's optimal result. Some specific implementations of the present invention will record the process of the user adjustment as well as the final choice with which the user is satisfied, and continuously optimize parameter configurations of the tool, so that the recommended keywords can improve the user's satisfaction.

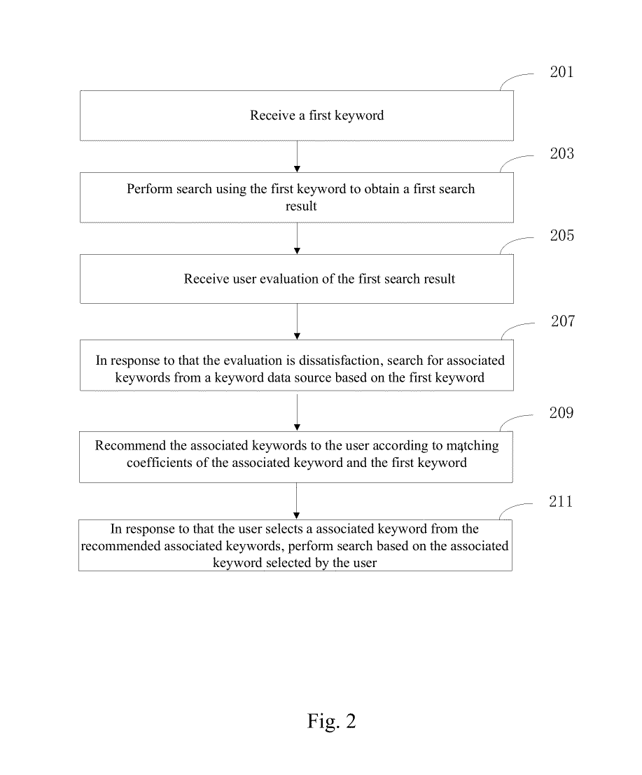

FIG. 2 shows a first specific implementation of a computer-implemented method for searching of the present invention, where a first keyword is received at step 201. The first keyword is determined by the user according to the information he/she needs to search and based on his/her knowledge. At step 203, the first keyword is used to search to obtain a first search result. Relevant search information can be obtained by using a common search engine, e.g., Google, Baidu (Baidu is a registered trade make of Baidu Co., Ltd.), and the like, and based on the first keyword input by the user. At step 205, the user evaluation of the first search result is received. In browsing the search information, the user can be satisfied or dissatisfied with the search result. Preferably, if not satisfied, the user can give an evaluation of dissatisfaction.

At step 207, in response to that the evaluation is unsatisfactory, associated keywords are searched for from a keyword data source based on the first keyword. If the user is not satisfied with the search result, the help providing associated keywords to the user will be enabled to provide related associated keywords by searching a keyword data source in real time. The keyword data source can be an encyclopedia website, a specialty dictionary, a document repository, and the like. Preferably, contents related to the first keyword can be determined from the keyword data source: the first keyword is used as an input word entry to match its related contents in the data source, after which, the associated keywords are extracted from the related contents. Preferably, they can be directly extracted according to the structure (category) of the keyword data source. For example, each structure or category will list related word entries, which are exactly the associated keywords that are to be extracted. Matching coefficients between the associated keywords and the first keyword can be determined according to the structure and different category of the keyword data source. The calculation of the matching coefficients need to be configured according to the sources of the associated keywords used by the system, and different keyword data sources will have different organizational structures for the contents of word entries, and the corresponding calculations of matching coefficients will also be different. Taking Wikipedia (www.wikipedia.org) as an example, apart from a segment of explanation and definition of an entry word at the beginning, Wiki also has some categories to describe the entry word, e.g., “See also”, “History”, and the like, and different categories represent the relationships between the entry words therein and the current entry word, and thus these categories can be used to define the matching coefficients. The configuration of matching coefficients can be shown as follows:

L1: “Frequently used terms”, “Explanation”, “see also”, “tags”

L2: “overview”, “history”

L3: “types”, “criteria”

where L1, L2 and L3 represent different levels of matching coefficients; when the matching coefficient is 1, it means the matching degree is the highest; when the coefficients are 2, 3 . . . , the matching degrees decrease successively. Further for example, for a date source like Baidu encyclopedia, the matching coefficients can be set as follows:

L1: “related word entries”, “synonyms”, “tags”

L2: “brief introduction”, “summary”, “category”

L3: “English explanation”, “further reading”

For a specialized word stock, the matching coefficient can be defined according to its organizational structure, and examples can be given as follows:

L1: “basic interpretation”, “popular interpretation from internet” and “industry interpretation”

L2: “related words”

L3: “related search”

If the user per se has deeper and accurate understanding of the structure and contents of the data source, he/she can also define the matching coefficients himself/herself. The calculation method for matching coefficients can be configured according to different types of data sources. In addition, the calculation of matching coefficients can be adjusted according to interaction of the user.

At step 209, associated keywords are recommended to the user according to the matching degrees of the associated keywords and the first keyword. Preferably, the associated keywords with high-level matching coefficients are preferentially recommended to the user, or the associated keywords with high-level matching coefficients and shortest distance are preferentially recommended to the user. The shortest distance can be defined by the user; e.g., if two entries do not have an inclusion relationship, the distance between the two entries can be defined as the shortest. At step 211, in response to that the user selects an associated keyword from the recommended associated keywords, search is performed based on the associated keyword selected by the user. The first specific implementation of the present invention can be realized by adding a plug-in in a common browser.

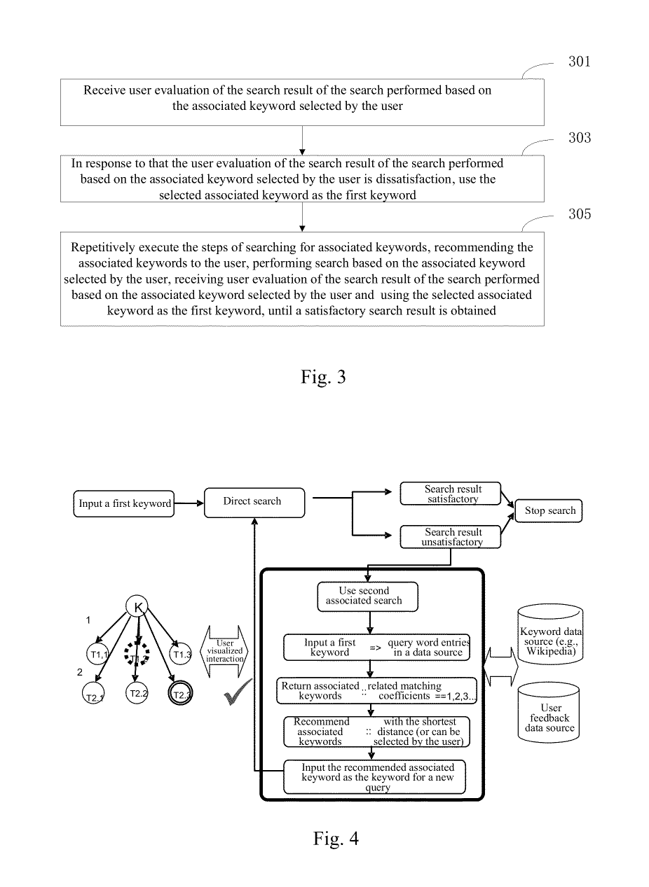

FIG. 3 shows a second specific implementation of the computer-implemented method for searching of the present invention, where at step 301, the user's evaluation of the search result of the search performed based on the associated keyword selected by the user is received. At step 303, in response to that the user's evaluation of the search result of the search performed based on the associated keyword selected by the user is unsatisfactory, the selected associated keyword is used as the first keyword. At step 305, iteratively execute the steps of searching for associated keywords, recommending the associated keyword to the user, performing search based on a associated keyword selected by the user, receiving user evaluation of the search result of the search performed based on the associated keyword selected by the user and using the selected associated keyword as the first keyword, until a satisfactory search result is obtained. By performing search of associated keywords iteratively as such, the keyword truly needed by the user can be better approached.

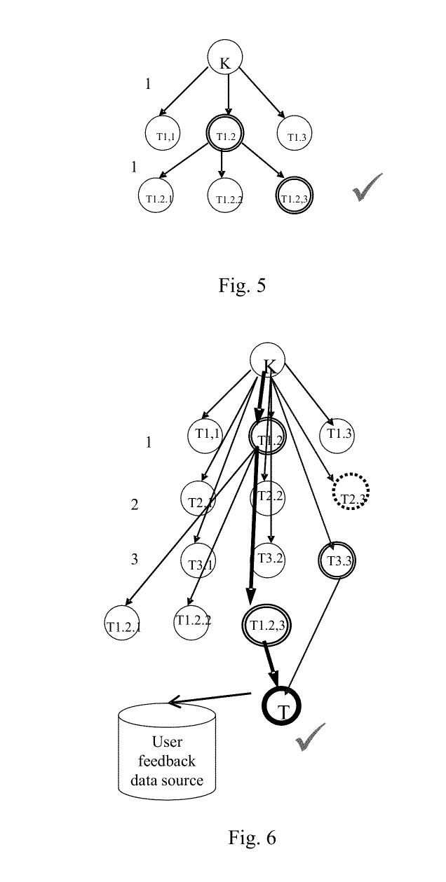

FIGS. 4 and 5 show a third specific implementation of the computer-implemented method for searching according to the present invention, where:

Phase 1: first, the user inputs a first keyword K, and the search engine executes a first search; if the user is satisfied with the search result, the search ends; otherwise, a second search is performed.

Phase 2: first the first keyword K input by the user is used a word entry to query in the corresponding date source, e.g., Wikipedia, and Baidu encyclopedia etc., then, according to the previously defined matching coefficients, associated keywords with a coefficient of 1 (e.g., T1.1, T1.2, T1.3 shown in FIG. 4) are found; and all the associated keywords with a coefficient of 1 are returned, from which the user can select a keyword for the second input; or a distance-defining algorithm configured in advance in the system can be used to return the associated keyword with the shortest distance as the keyword of the second input (e.g., T1.2 shown in FIG. 4);

Phase 3: the user uses T1.2 as the input keyword to perform the second search; if the returned result is satisfactory, the search ends; otherwise, the user can choose to select other keywords with a matching coefficient of 1 as the input keyword to return the search result again. Or a search for associated keywords can be performed again. The present embodiment can provide two searching structures. One is as shown in FIG. 4, in which the first keyword K is still used as the center word to find associated keywords with a matching coefficient of 2 (T2.1, T2.2, T2.3), and then a related keyword is selected as the keyword for re-input according to the method for phase 2. Another method for searching for associated keywords is as shown in FIG. 5. This method uses the previously selected input keyword as a word entry (T1.2), and uses it as the center to find associated keywords with a matching coefficient of 1 therewith (T1.2.1, T1.2.2, T1.2.3), and then selects an associated keyword as the keyword for re-input according to the method for phase 2.

Phase 4: the above processes are repeated, until the search result obtained from the input associated keyword satisfies the user's requirement, when the searches end.

As shown in FIG. 6, in the above phase 4, the search path and the keyword matching result (the first keyword K input by the user at the first time, the associated keyword K selected finally of which the search result is satisfactory) of this time can be recorded and stored in a user feedback data source for adjustment of matching coefficients by the system. At the same time, if the user is willing to disclose and share his/her search path, the user's search path and keyword matching result can be stored in a shared user feedback data source. Further optimization will be obtained through the search path, and the provision of suggested words tends to be more accurate. FIG. 6 shows that two users input the first keyword K at first, they use different keywords according to the method for the present invention and finally both get a satisfactory search result, finding a corresponding keyword T, which can be a different word specifically; where, one passes user through K->T1.2->T.1.2.3->T, and the other user passes through K->T3.3->T. Both of the above two paths need to be stored, and the usage frequency (number of times) of each path by users is also stored. Then when a start word or an intermediate word of a path is input by a user as the first input keyword, the end word of the path which has been selected by users more times can be directly recommended to the user as the associated keyword. In this way, the user can share the finally satisfactory matching keyword with other users, and the matching coefficients in the user feedback data source can be adjusted correspondingly. Thus, next time, T will preferentially appear in the keyword list corresponding to K.

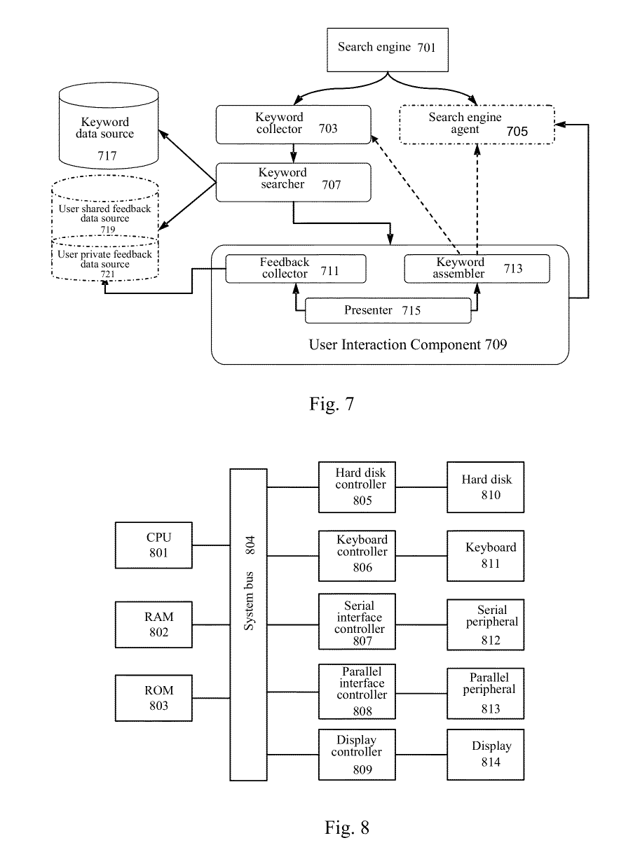

As shown in FIG. 7, the present invention further provides a computer system for searching. The system includes: a search engine 701, a keyword collector 703, a keyword searcher 707, a user interaction component 709, a keyword data source 717; where the keyword collector 703 is configured to receive the first keyword; the search engine 701 is configured to perform search using the first keyword to obtain a first search result; the user interaction component 709 is configured to receive user evaluation of the first search result; the keyword searcher 707 is configured to, in response to that the evaluation is unsatisfactory, search for associated keywords from a keyword data source based on the first keyword; where the keyword interaction component 709 is further configured to recommend associated keywords to the user according to the matching degrees of the associated keywords and the first keyword, and the search engine 701 is further configured to, in response to that the user selects an associated keyword from the recommended associated keywords, perform search based on the associated keyword selected by the user.

Preferably, the user interaction component 709 further includes a feedback collector 711, a keyword assembler 713 and a presenter 715. The user interaction component 709 is for helping the user to present the keywords and search paths suggested by the system; on visualized graphics, the user can select a suggested keyword to search directly, and the keyword assembler 713 will assemble the required keyword format according to different search engines, and finally invoke a search engine agent 705 to feedback to the search engine to perform search again (of course, the search engine agent 705 is not necessary, and the keyword can be directly sent to the keyword collector 703 to perform search). The keyword path and keyword matching selected and fed back by the user can be transmitted through the feedback collector 711 to a user shared feedback data source 719 in the user feedback data source to be shared with other search users, or can be transmitted to a user private feedback data source 721 in the user feedback data source to be used only by the user.

Preferably, the keyword data source 717 is an encyclopedia website.

Preferably, the keyword searcher 707 further includes: a content determiner configured to determine contents related to the first keyword from a keyword data source; an extractor configured to extract the associated keywords from the related contents; a matching coefficient determiner configured to determine matching coefficients of the associated keywords and the first keyword according to the structure of the keyword data source.

Preferably, the user interaction component 709 is further configured to preferentially recommend the associated keywords with high-level matching coefficients to the user.

Preferably, the user interaction component 709 further includes an evaluation receiver configured to receive user evaluation of the search result of the search performed based on the associated keyword selected by the user. The search engine 701 is further configured to, in response to that the user evaluation of the search result of the search performed based on the associated keyword selected by the user is unsatisfactory, receiving another associated keyword of the same level selected by the user to perform the search again.

Preferably, the feedback collector 711 is configured to store the path of associated keywords that the user selects and the usage frequency thereof to form a user feedback database.

Preferably, the user interaction component 709 is further configured to recommend the associated keywords in an associated keyword path with high usage frequency to the user.

FIG. 8 schematically shows a structural block diagram of a computing device which can realize embodiments according to the present invention. The computer system shown in FIG. 8 includes a CPU (central processing unit) 801, RAM (random access memory) 802, ROM (read-only memory) 803, a system bus 804, a hard disk controller 805, a keyboard controller 806, a serial interface controller 807, a parallel interface controller 808, a display controller 809, a hard disk 810, a keyboard 811, a serial peripheral 812, a parallel peripheral 813 and a display 814. Among these components, the CPU 801, RAM 802, ROM 803, hard disk controller 805, keyboard controller 806, serial interface controller 807, parallel interface controller 808 and display controller 809 are connected with the system bus 804. The hard disk 810 is connected with the hard disk controller 805; the keyboard 811 is connected with the keyboard controller 806; the serial peripheral 812 is connected with the serial interface controller 807; the parallel external device 813 is connected with the parallel interface controller 808, and the display 814 is connected with the display controller 809.

The functions of each component in FIG. 8 are well known in the art, and the structure shown in FIG. 8 is also conventional. Such structure is not only applied in personal computers, but also in handheld devices, e.g., Palm PCs, PDAs (personal digital assistant), mobile phones. In different applications, e.g., for implementing a user terminal that contains the client module according to the present invention or a server host containing the network application server of the present invention, the structure shown in FIG. 8 can be added with some components, or some components in FIG. 8 can be omitted. The entire system shown in FIG. 8 is usually controlled by computer readable instructions stored in the hard disk 810, or stored in the EPROM or other non-volatile memory as software. The software can also be downloaded from a network (not shown), or stored in the hard disk 810, or the software downloaded from network can be loaded into the RAM 802, executed by the CPU 801, so as to accomplish the functions determined by the software.

While the computer system described in FIG. 8 can support the technical solutions provided by the present invention, this computer system is only an example of computer systems. Those skilled in the art can appreciate that many other computer system designs can also realize the embodiment of the present invention.

Although here the exemplary embodiments of the present invention is described with reference to the accompanying drawings, it should be appreciated that the present invention is not limited to these precise embodiments; moreover, those of ordinary skill in the art can make various changes and modifications to the embodiments without departing from the scope and objectives of the present invention. All these changes and modifications are intended to be included in the scope of the present invention defined by the appended claims.

Moreover, according to the above description, those skilled in the art know that the present invention can be embodied as an apparatus, a method or a computer program product. Therefore, the present invention can specifically take the following forms, i.e., an entirely hardware, an entirely software (including firmware, resident software, microcode, and the like), or a combination of software part and hardware part generally called “circuit”, “module” or “system” herein. In addition, the present invention can take the form of a computer program product embodied in any tangible medium of expression, in which computer readable program code is included.

Any combination of one or more computer readable or computer usable mediums can be used. The computer readable or computer usable medium can be, for example, but not limited to, an electronic, magnetic, optical, electromagnetic, infrared or semiconductor system, apparatus, device, or propagation medium. More specific examples (a non-exhaustive list) of computer readable medium include the following: an electrical connection having one or more wires, a portable computer diskette, a hard disc, a random access memory (RAM), a read-only memory (ROM), an erasable programmable read-only memory (EPROM or flash memory), an optical fiber, a portable compact disc read-only memory (CD-ROM), an optical storage device, a transmitting medium supporting the Internet or intranet, or a magnetic storage device. It should be noted that the computer readable or computer usable medium can even be, a paper or other suitable mediums with programs printed thereon, because, for example, the program can be obtained in a electrical manner by electrically scanning such a paper or other medium, and compiled, interpreted or processed in a proper manner, and stored in a computer storage if necessary. In the context of this document, a computer readable or computer usable medium can be any medium that can contain, storage, deliver, broadcast or transmit programs for use by or in connection with an instruction execution system, apparatus or device. The computer readable medium can include a data signal with computer readable program code embodied therein and propagated in a baseband or as part of a carrier wave. The computer readable program code can be transmitted by any proper medium, including but limited to, wireless, cable, optical fiber cable, RF, and the like.

Computer program code for carrying out operations of the present invention can be written in any combination of one or more programming languages, including an object oriented programming language such as Java, Smalltalk, C++, or the like, and conventional procedural programming languages, such as “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet service provider).

In addition, each block of the flowcharts and/or block diagrams, as well as combinations of the blocks in the flowcharts and/or block diagrams of the present invention, can be implemented by computer program instructions. These computer program instructions can be provided to a processor of a general purpose computer, a special purpose computer, or other programmable data processing apparatus to produce a machine, such that instructions, which are executed via the processor of the computer or other programmable data processing apparatus, create means for implementing the functions/actions specified in the blocks in the flowcharts and/or block diagrams.

These computer program instructions can also be stored in a computer readable medium that can direct a computer or other programmable data processing apparatus to function in a particular manner, such that the instructions stored in the computer readable medium produce a manufactured article including instruction means that implement the functions/actions specified in the blocks in flowcharts and/or block diagrams.

The computer program instructions can also be loaded into a computer or other programmable data processing apparatus, to cause a series of operation steps to be performed on the computer or the other programmable apparatus, to produce a computer implemented process such that the instructions which are executed on the computer or other programmable apparatus provide a process of implementing the functions/actions specified in the blocks of flowcharts and/or block diagrams.

The flowcharts and block diagrams in the figures illustrate the architecture, functionality and operations of possible implementations of the system, method and computer program product according to various embodiments of the present invention. In this regards, each block in the flowcharts or block diagrams can represent a module, segment, or portion of code, which includes one or more executable instructions for implementing specific logic function(s). It should also be noted that, in some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or actions, or combinations of special purpose hardware and computer instructions.

We claim:

1. A computer system for searching, said system comprising:
a keyword collector configured to receive a first keyword;
a search engine configured to perform a search using the first keyword to obtain a first search result;
a user interaction component configured to receive user evaluation of the first search result;
a keyword searcher configured to, in response to the user evaluation being unsatisfactory, search for associated keywords from a keyword data source based on the first keyword;
wherein, the user interaction component is further configured to recommend the associated keywords to the user according to matching degrees of the associated keywords and the first keyword; and
the search engine is further configured to, in response to the user selecting an associated keyword from the recommended associated keywords, perform a search based on the associated keyword selected by the user.

2. The system of claim 1, wherein the keyword data source is an encyclopedia website.

3. The system of claim 1, wherein the keyword searcher further comprise:
a content determiner configured to determine contents related to the first keyword from the keyword data source;
an extractor configured to extract the associated keywords from the related contents;
a matching coefficient determiner configured to determine matching coefficients of the associated keywords and the first keyword according to structure of the keyword data source.

4. The system of claim 3, wherein the user interaction component is configured to preferentially recommend the associated keywords with high-level matching coefficients to the user.

5. The system of claim 3, wherein:
the user interaction component is further configured to receive the user evaluation of the search result of the search performed based on the associated keyword selected by the user;
the search engine is further configured to, in response to the user evaluation of the search result of the search performed based on the associated keyword selected by the user being unsatisfactory, receive another associated keyword of the same level selected by the user to perform the search based on the associated keyword again.

6. The system of claim 1, wherein
the user interaction component further comprises a feedback collector configured to store the a path in which the user selected the associated keywords as well as the usage frequency thereof to form a user feedback data source,
the user interaction component is further configured to recommend the associated keywords in the associated keyword path and with a high usage frequency to the user.
